(19) United States
(12) Patent Application Publication
(10) Pub. No.: US 2025/0136821 A1
(43) Pub. Date: May 1, 2025

(54) AQUEOUS-EMULSION OIL-RESISTANT COATING MATERIAL, METHOD FOR PRODUCING PAPER, AND PAPER HAVING COATING LAYER INCLUDING AQUEOUS-EMULSION OIL-RESISTANT COATING MATERIAL

(71) Applicant: SEIKO PMC CORPORATION, Tokyo (JP)

(72) Inventor: Yoshiyuki MITANI, Chiba (JP)

(73) Assignee: SEIKO PMC CORPORATION, Tokyo (JP)

(21) Appl. No.: 18/835,336

(22) PCT Filed: Jan. 24, 2023
(86) PCT No.: PCT/JP2023/002084

§ 371 Date: Aug. 1, 2024

(30) Foreign Application Priority Data
Feb. 14, 2022 (JP) 2022-020598

(51) Int. Cl. C09D 5/02; C09D 129/04; C09D 189/00; C09D 191/06; D21H 19/18; D21H 19/20

(52) U.S. Cl. CPC C09D 5/022; C09D 129/04; C09D 189/005; C09D 191/06; D21H 19/18; D21H 19/20

(57) ABSTRACT

[Problem] To provide an aqueous-emulsion oil-resistant coating material excellent in terms of air permeability, oil resistance, and carbon neutrality, by using a bio-derived component as a main component. [Solution] An aqueous-emulsion oil-resistant coating material comprising component (a), which is hydrogenated castor oil and/or rice wax, component (b), which is poly(vinyl alcohol) and/or casein, and water; a method for producing paper, characterized by applying the aqueous-emulsion oil-resistant coating material; and paper having a coating layer including the aqueous-emulsion oil-resistant coating material.

### TECHNICAL FIELD

The invention relates to an aqueous-emulsion oil-resistant coating material which increases carbon neutrality by using a bio-derived component as a main component, as well as paper using the same.

### RELATED ART

Paper and paperboards are widely used as packaging materials for food, etc. In particular, for food that contains a lot of oil or fats, oil-resistant paper or paperboards are used to prevent the oil from penetrating through the packaging paper. Conventionally, fluororesin-based oil-resistant materials have been used as a means of imparting oil resistance to paper. However, when fluororesin-based oil-resistant materials are heated to 100° C. or higher, persistent fluorinated hydrocarbons may be generated, which causes an adverse effect to health or environment. Therefore, techniques for replacing fluororesin-based oil-resistant materials are under development. As techniques without using a fluororesin-based oil-resistant material, paper products (Patent Document 1) containing a coating film of hydrophobized starch or grease-resistant paper (Patent Document 2) having an oil-resistant layer made of styrene-acrylic resin and polyvinyl alcohol resin are known. However, both of them aim to ensure oil resistance by relying on the film-forming function of the coating layer, and therefore are not suitable for applications requiring both breathability and oil resistance. In order to increase both breathability and oil resistance, oil-resistant paper (Patent Document 3) containing starch with a hydrophobic group and wax and exhibiting high breathability and oil resistance is disclosed. However, such oil-resistant paper does not have satisfactory breathability Also, recently, as the demand for establishing a recycling-oriented society grows, there is a desire to move away from fossil fuels, and so-called bio-derived components with excellent carbon neutrality are attracting attention. However, it is difficult to use bio-derived raw materials while satisfying high breathability and oil resistance, and an oil-resistant material satisfying such demands is sought for.

### PRIOR ART DOCUMENT(S)

### Patent Document(s)

Patent Document 1: Japanese Laid-open No. 2002-069889
Patent Document 2: Japanese Laid-open No. 2021-080591
Patent Document 3: Japanese Laid-open No. 2013-237941

### SUMMARY OF INVENTION

### Technical Problem

In view of the above, an objective of the invention is to provide an aqueous-emulsion oil-resistant coating material capable of attaining oil-resistant paper excellent in terms of carbon neutrality by using a bio-derived component and having high air permeability and oil resistance, a method for producing paper coated with the aqueous-emulsion oil-resistant material, and paper having a coating layer including the aqueous-emulsion oil-resistant coating material.

### Solution to Problem

That is, the invention provides the following.
<1> An aqueous-emulsion oil-resistant coating material, including: Component (a), which is hardened castor oil and/or rice wax; Component (b), which is polyvinyl alcohol and/or casein; and water;
<2> the aqueous-emulsion oil-resistant coating material according to <1>, where a ratio of Component (a) and Component (b) is included in a ratio of Component (a)/Component (b)=100/1 to 20 as a mass ratio;
<3> the aqueous-emulsion oil-resistant coating material according to <1>, where Component (a) is hardened castor oil;
<4> the aqueous-emulsion oil-resistant coating material according to <1>, where Component (b) is casein;
<5> a method for producing paper, including coating the aqueous-emulsion oil-resistant coating material according to any one of <1> to <4>;
<6> paper, having a coating layer comprising the aqueous-emulsion oil-resistant coating material according to any one of <1> to <4>.

### Effects of Invention

According to the invention, an oil-resistant coating material having high breathability and oil resistance as well as high carbon neutrality and low environmental load for using hardened castor oil and/or rice wax that is a bio-derived component as the main component can be obtained.

### DESCRIPTION OF EMBODIMENTS

In the following, the embodiments of the invention are described in detail. The embodiment is an aspect for implementing the invention, and the invention shall not be limited by such embodiment. In the specification, while “part(s)” or “%” is used, such usage is based on mass. In addition, numerical ranges indicated by using “-” or “to” include the numerical values set forth before and after the symbol.

An oil-resistant coating material includes Component (a) that is hardened castor oil and/or rice wax, polyvinyl alcohol and/or casein as Component (b), and water.

### Component (a) as Hardened Castor Oil and/or Rice Wax

Component (a) is used for imparting oil resistance, and is hardened castor oil or rice wax or both of hardened castor oil and rice wax. Component (a) is preferably hardened castor oil.

The hardened castor oil included in Component (a) is a hydrogenated material of castor oil, and also called hydrogenated castor oil. Castor oil is a type of vegetable oil extracted from castor seeds, and has ricinoleic acid glyceride that is an unsaturated fatty acid as the main component and glycerides of oleic acid, linoleic acid and a small amount of saturated fatty acid as other components.

The rice wax included in Component (a) is natural wax extracted from rice bran oil. Rice wax is also called rice bran wax. The main component of rice wax is an ester of higher fatty acid and higher alcohol, and also contains free higher fatty acids, higher alcohols, and a small amount of hydrocarbon.

### Component (b) as Polyvinyl Alcohol and/or Casein

Component (b) is used for facilitating the dispersion stability of the emulsification or emulsion of Component (a), and from the perspective of reducing the adverse effect toward the breathability after coating is performed on paper and the perspective of the oil resistance of the coating film after drying, it is necessary to include at least one selected from polyvinyl alcohol and casein. Among the above, it is preferable to use casein from the perspective of carbon neutrality.

Polyvinyl alcohol used in Component (b) preferably has a degree of saponification of 70 mol % to 99 mol %, more preferably 80 mol % to 90 mol %.

The proportions of Component (a) and Component (b) included in the oil-resistant coating material of the invention, by weight ratio, are preferably as follows: Component (a)/Component (b)=100/1 to 20. If the proportion of Component (b) is equal to less than 1, the emulsification stability of Component (a) may be insufficient, and if the proportion of Component (b) is equal to or greater than 20, the viscosity of the coating liquid may be too high, thus affecting and the coating suitability.

### Other Waxes

A wax type other than Component (a) can also be used together with the oil-resistant coating material, as long as the breathability and oil-resistance are not deteriorated.

As the wax type other than Component (a), examples may include the following: vegetable wax other than rice wax, such as haze wax, urushi wax, carnauba wax, or candelilla wax; animal wax such as beeswax, shellac wax, or lanolin; vegetable-based hardened oil made by hardening (hydrogenating) vegetable oil other than castor oil, such as soybean oil, rapeseed oil, palm oil, coconut oil, and rice oil, etc.; animal-based hardened oil made by hardening (hydrogenating) beef tallow or lard; mineral wax such as montan wax or ozokerite wax; petroleum wax such as paraffin wax and microcrystalline wax; and synthetic wax such as Fischer-Tropsch wax, polyethylene wax, fatty acid ester wax, and fatty acid amide wax, etc. Among the above, one or a combination of multiple of the materials can be used. Among the above, from the perspective of carbon neutrality, it is favorable to use together a vegetable-based wax and an animal-based wax that are bio-derived.

### Other Emulsification Dispersants

In the oil-resistant materials of the invention, in addition to Component (b), other nonionic, anionic, cationic or amphoteric emulsification dispersants can also be used in combination. Such other nonionic, anionic, cationic or amphoteric emulsification dispersant is preferably within the range of 0 to 10 parts by mass with respect to 100 parts by mass of the total of Component (a), in order not to deteriorate the effect or stability.

As the nonionic emulsification dispersant, examples may include polyoxyethylene alkyl ethers, polyoxyethylene fatty acid esters, glycerin fatty acid esters, propylene glycol fatty acid esters, polyoxyethylene alkyl phenyl ethers, polyoxyethylene polycyclic phenyl ethers, polyoxyalkylene alkyl ethers, polyoxyethylene sorbitan esters, polyoxyethylene sorbitol fatty acid esters, sucrose fatty acid esters, polyoxyethylene hardened castor oil, alkyl imidazolines etc. As the anionic emulsification dispersant, examples may include: anionic synthetic emulsification dispersants, such as sodium alkylbenzene sulfonate,ammonium alkyl sulfate or sodium dialkyl sulfosuccinate, styrene-maleic anhydride copolymers, α-olefin-maleic anhydride copolymers, diisobutylene-maleic anhydride copolymers, isobutylene-maleic anhydride copolymers, styrene-acrylic polymer emulsifiers, acrylic polymer emulsifiers, etc.; anionic natural emulsification dispersants such as surfactin, sophorolipid, shellac, rosin, higher fatty acids such as stearic acid and palmitic acid, and their salts; and anionic modified natural emulsification disperants such as carboxymethyl cellulose, octenyl succinic anhydride modified starch, oxidized starch, hydroxypropyl xanthan gum, and sulfated castor oil. As the cationic emulsification dispersant, examples may include, for example: cationic surfactants such as alkyltrimethylammonium chloride, dialkylammonium chloride, and benzylammonium chloride, and chitosan salts, or cationic modifications of starch, cellulose, and polyvinyl alcohol, etc. As the amphoteric emulsification dispersant, examples may include: amphoteric synthetic low molecular weight emulsification dispersants such as alkyldimethylaminoacetate betaine or monosodium alkylaminodiacetate, and amphoteric natural low molecular weight emulsification dispersants such as lecithin (including hydrogenated and hydroxide products). Among the above, one or a combination of multiple of the materials can be used. Among the above, sulfated castor oil, palmitic acid, are preferred.

### Other Additives

In the oil-resistant coating material of the invention, in addition to Components (a) and (b), various additives generally used in a painting material, such as, a viscosity modifier, a defoamer, a preservative, a leveling agent, a dye, a surface tension modifier, a lubricant, an anti-blocking agent, an antioxidant, a UV absorber, as long as the breathability and the oil resistance thereof are not deteriorated.

### Emulsification Method

The method for forming the emulsion of the oil-resistant coating material of the invention is not particularly limited, and any conventionally known method can be used. For example, conventional methods, such as conventional methods as follows can be used: a method of adding Component (a) to a water solution of Component (b) and stirring at a high temperature; a solvent method of dissolving Component (a) in a solvent, adding Component (b) and water to perform high-pressure emulsification, and removing the solvent through distilling; a phase inversion emulsification method, in which an aqueous solution of Component (b) is dropped onto molten Component (a) to convert the water-in-oil type into an oil-in-water type; and a high-pressure emulsification or ultrasonic emulsification method for performing high-pressure emulsification, after mixing at a high-pressure, high-temperature environment. Among the above, the emulsion is preferably formed by the high-pressure emulsification method. The timing of adding Component (b) is not particularly limited. Component (b) may be added in full amount before the process of emulsifying Component (a), and a portion of Component (b) may be separated and added after Component (a) is emulsified.

The solid content of the oil-resistant coating material of the invention is preferably 10% or more and 55% or less, and more preferably 15% or more and 50% or less. If the solid content exceeds 55%, the viscosity may increase over time, and the solid content concentration at the liquid surface may increase during storage, making it easier for agglomerates to form (skinning). If it is less than 10%, the amount of the active component decreases, which is not economical.

The solid content of the invention is a percentage of the residual mass after heating the aqueous-emulsion oil-resistant coating material at 150° C. for 20 minutes with respect to the mass before heating.

A typical application of the aqueous-emulsion oil-resistant coating material of the invention is to coat the coating material on paper.

### Paper

The paper used in the embodiment means paper and/or paperboard, and any ordinary paper or paperboard containing biodegradable pulp as a main component can be used without any particular limitation. Specific examples include fine paper, pure white roll paper, unbleached or bleached Kraft paper, glassine paper, coated paper, liner base paper, paper tube base paper, white cardboard, chipboard, and the like.

### Method for Producing Paper, Specifically, Coating of the Oil-Resistant Coating Material of the Invention

It is possible that the method of coating the oil-resistant coating material according to the invention onto paper is particularly limited, as long as a conventional process is used. Examples may include: bar coating, blade coating, die coating, curtain coating, air knife coating, spray coating, gravure coating, flexo coating, size press coating.
In addition, the oil-resistant coating material of the invention can be used in single-layered or multi-layered coating, and is also applicable to single-sided or double-sided coating. The coating amount of the oil-resistant coating material is not particularly limited, and is preferably 1 g/m² to 10 g/m² from the perspective of oil resistance and cost.

The oil-resistant material of the invention may also be used with various heat-sealing materials to impart heat-sealing properties to the coating layer. Examples of the heat-sealing material may include thermosetting resins such as acrylic resins, polyester resins, vinyl chloride acetate resins, and thermosetting urethane resins.

The oil-resistant coating material of the invention and the heat-sealing material can also be mixed and coated. In addition, the oil-resistant coating material of the invention and the heat-sealing material can also be coated separately for multiple layers. In such case, regarding the coating order of the oil-resistant coating material of the invention and the heat-sealing material, it does not matter which one is coated first. Moreover, the heat-sealing material can also be coated on a surface opposite to the coating surface of the paper on which the oil-resistant layer of the invention is coated.

Between the paper and the coating layer including the oil-resistant coating material of the invention, a coating layer for liquid absorption control, or a coating layer for smoothing the unevenness of the paper surface, etc., may also be provided.

The method for drying the wet coating film can be any known method without limitation. Examples may include cylinder heating, steam heating, hot air heating, infrared heating, high frequency heating, etc.

### EXAMPLE

The invention will be specifically explained below based on examples, but the invention is not limited to the examples.

### Example of Dissolving Casein

200 parts of casein (manufactured by Fujifilm Wako Pure Chemical Industries, Ltd.), 15 parts of 28% aqueous ammonia, and 785 parts of water were placed in a four-neck separable flask equipped with a heating device, a stirring device, a cooling tube, and a thermometer, the temperature was raised to 85° C. with stirring, and dissolution was carried out over 20 minutes while the temperature was maintained, to obtain a casein solution with a concentration of 20% (casein liquid).

### Preparation of the Aqueous-Emulsion Oil-Resistant Coating Material

### Oil-Resistant Coating Material 1

262 parts of water and 14 parts of polyvinyl alcohol (manufactured by Kuraray Co., Ltd., product name: 5-88) were charged into a four-neck separable flask equipped with a heating device, a stirring device, a cooling tube, and a thermometer, the temperature was raised to 90° C. with stirring, the mixture was then stirred for 60 minutes while the temperature was maintained, and polyvinyl alcohol was dissolved. Then, 200 parts of hardened castor oil (manufactured by ITO OIL CHEMICALS CO.,LTD., product name: hardened castor oil A) was added, and then the temperature was raised to 95° C. with stirring, and the mixture was stirred for 10 minutes while the temperature was maintained to prepare an emulsion. Then, the emulsion was subjected to a high-pressure emulsification process (emulsification pressure of 200 kgf/cm²) by using a Manton-Gaulin emulsifier to obtain a uniform emulsion. Then, the emulsion was mixed with 237 parts of water with stirring and cooled to a temperature of 40° C. or lower to obtain Oil-resistant coating material 1 with a solid content of 30%.

### Oil-Resistant Coating Materials 2 to 4, 8 to 9, 11 to 14

Oil-resistant coating materials 2 to 4, 8 to 9, and 11 to 14 were obtained in the same manner as Oil-resistant coating material 1, except that the types, weight ratios, and solid contents of Components (a) and (b) were changed as shown in Table 1.

### Oil-Resistant Coating Material 5

270 parts of water, 30 parts of 20% casein solution (casein liquid), and 6 parts of polyvinyl alcohol (manufactured by Kuraray Co., Ltd., product name: 5-88) were charged into a four-neck separable flask equipped with a heating device, a stirring device, a cooling tube, and a thermometer, the temperature was raised to 90° C. with stirring, the mixture was stirred for 60 minutes while the temperature was maintained, and polyvinyl alcohol was dissolved. Then, 200 parts of hardened castor oil (manufactured by ITO OIL CHEMICALS CO.,LTD., product name: hardened castor oil A) was added, and then the temperature was raised to 95° C. with stirring, and the mixture was stirred for 10 minutes while the temperature was maintained to prepare an emulsion. Then, the emulsion was subjected to a high-pressure emulsification process (emulsification pressure of 200 kgf/cm²) by using a Manton-Gaulin emulsifier to obtain a uniform emulsion. Then, the emulsion was mixed with 201 parts of water with stirring. The mixture was cooled to a temperature of 40° C. or lower to obtain Oil-resistant coating material 5 with a solid content of 30%.

### Oil-Resistant Coating Materials 6 to 7 and 10

Oil-resistant coating materials 6 to 7 and 10 were obtained in the same manner as Oil-resistant coating material 5, except that the types and weight ratios of Components (a) and (b) were changed as shown in Table 1.

### Oil-Resistant Coating Material 15

Oil-resistant coating material 15 was adjusted by trying make adjustment in the same way as the case of Oil-resistant coating material 1, except that the types, weight ratios, and solid contents of

Components (a) and (b) were changed as shown in Table 1. However, the emulsion properties were poor and it was difficult to obtain a stable emulsion.

### Oil-Resistant Coating Material 16

270 parts of water and 6 parts of polyvinyl alcohol (manufactured by Kuraray Co., Ltd., product name: 5-88) were charged into a four-neck separable flask equipped with a heating device, a stirring device, a cooling tube, and a thermometer, the temperature was raised to 90° C. with stirring, the mixture was then stirred for 60 minutes while the temperature was maintained, and polyvinyl alcohol was dissolved. Then, 200 parts of hardened castor oil (manufactured by ITO OIL CHEMICALS CO.,LTD., product name: hardened castor oil A) was added, and then the temperature was raised to 95° C. with stirring, and the mixture was stirred for 10 minutes while the temperature was maintained to prepare an emulsion. Then, the emulsion was subjected to a high-pressure emulsification process (emulsification pressure of 200 kgf/cm²) by using a Manton-Gaulin emulsifier to obtain a uniform emulsion. Then, the mixture was poured into a liquid mixture of 201 parts of water and 30 parts of a 20% casein solution (casein liquid) with stirring. The mixture was cooled to a temperature of 40° C. or lower to obtain Oil-resistant coating material 16 with a solid content of 30%.

### Oil-Resistant Coating Material 17

100 g of commercially available oxidized corn starch (manufactured by Nippon Shokuhin Kako Co., Ltd., product name: MS#3800) (solid content 10%) that had been gelatinized at 90° C. for 30 minutes was mixed with 17.8 g of Oil-resistant coating material 13 to obtain Oil-resistant coating material 17 with a solid content of 13%.

TABLE 1

| | | | | | | | | Solid |
|---|---|---|---|---|---|---|---|---|
| | | Others | Weight | | Weight | Others | Weight | component |
| | Component (a) | Wax | ratio | Component (b) | ratio | Emulsifier | ratio | (%) |
| Oil-resistant coating material 1 | Hardened castor oil | | 100 | PVA | 7 | | | 30 |
| Oil-resistant coating material 2 | Hardened castor oil | | 100 | Casein | 1 | | | 30 |
| Oil-resistant coating material 3 | Hardened castor oil | | 100 | Casein | 7 | | | 30 |
| Oil-resistant coating material 4 | Hardened castor oil | | 100 | Casein | 20 | | | 30 |
| Oil-resistant coating material 5 | Hardened castor oil | | 100 | Casein | 3 | | | 30 |
| | | | | PVA | 3 | | | |
| Oil-resistant coating material 6 | Hardened castor oil | | 100 | Casein | 3 | Sulfated | 1 | 30 |
| | | | | | | castor oil | | |
| Oil-resistant coating material 7 | Hardened castor oil | | 100 | Casein | 3 | Palmitic | 1 | 30 |
| | | | | | | acid | | |
| Oil-resistant coating material 8 | Rice wax | | 100 | Casein | 7 | | | 30 |
| Oil-resistant coating material 9 | Hardened castor oil | | 75 | Casein | 7 | | | 30 |
| | Rice wax | | 25 | | | | | |
| Oil-resistant coating material 10 | Rice wax | | 100 | Casein | 3 | | | 30 |
| | | | | PVA | 3 | | | |
| Oil-resistant coating material 11 | Hardened castor oil | | 100 | | | Oxidized | 7 | 20 |
| | | | | | | starch | | |
| Oil-resistant coating material 12 | Hardened castor oil | | 100 | | | CMC | 7 | 20 |
| Oil-resistant coating material 13 | | Paraffin | 100 | PVA | 7 | | | 30 |
| Oil-resistant coating material 14 | | Paraffin | 100 | Casein | 7 | | | 30 |
| Oil-resistant coating material 15 | | Carnauba | 100 | Casein | 3 | | | — |
| | | wax | | PVA | 3 | | | |
| Oil-resistant coating material 16 | Hardened castor oil | | 100 | Casein | 3 | | | 30 |
| | | | | PVA | 3 | | | |
| Oil-resistant coating material 17 | | Paraffin | 100 | PVA | 7 | Oxidized | 200 | 13 |
| | | | | | | starch | | |

PVA: Polyvinyl alcohol (manufactured by Kuraray Co., Ltd., product name: 5-88)
Oxidized starch: Oxidized corn starch (manufactured by Nippon Shokuhin Kako Co., Ltd., product name: MS#3800)
CMC: Carboxymethylcellulose sodium salt (manufactured by Daicel Corporation, product name CMC Daicel 1110)
Rice wax: Product name: Rice wax SS-2, manufactured by BOSO Oil Co., Ltd.
Paraffin wax: Product name: Paraffin Wax-135, manufactured by Nippon Seiro Co., Ltd.
Sulfated castor oil: Product name: Sulfated castor oil K, Takemoto Oil Co., Ltd.
Palmitic acid: Product name: Palmitic acid, manufactured by Junsei Chemical Co., Ltd.
Carnauba wax: Product name: Carnauba wax (No. 1), Manufactured by Yamakei Sangyo Co., Ltd.

### Coating of the Oil-Resistant Coating Material

The coating conditions of the oil-resistant coating materials and the measurement or evaluation methods for each evaluation item were as follows.

### Coating Base Paper

Single-sided glazed bleached Kraft paper: basis weight: 50 g/m²

### Coating

Each oil-resistant coating material was coated on the non-glossy surface of the base paper using a bar coater (bar No. 14) so that the adhesion amount of each oil-resistant coating material was 7 g/m² in solid content, and then dried using a hot air dryer at 110° C. for 0.5 minutes. Thereafter, the humidity of the item was conditioned at 23° C. and 50% RH for 24 hours, and then a Kit value, which is the index of oil resistance, as well as air permeability, which is an index of breathability, were measured.
(Kit value): Evaluated according to JAPAN TAPPI No. 41 The greater the number, the more favorable the oil resistance. From a practical standpoint, when a wide range of uses are envisaged, a Kit value of 5 or more is desirable.
(Air permeability) The measurement was carried out using PPS (Parker Print Surf) manufactured by MESSMER. The smaller the number, the more favorable the breathability. In the case where it is assumed that the material is used for a purpose requiring breathability, an air permeability of 250 seconds or less is practical.

### Example 1

The oil-resistant coating material 1 was coated on the single-sided glazed bleached Kraft paper according to the above conditions and was dried to obtain paper coated with the oil-resistant coating material. After the humidity was adjusted, the Kit value and the breathability were measured. The results were shown in Table 2.

### Examples 2 to 11, Comparative Examples 3 to 4

As shown in Table 2, except that the oil-resistant coating material was changed, paper coated with the oil-resistant coating materials was obtained like Example 1. In addition, in the same way as in Example 1, the Kit value and the breathability were measured. The results were shown in Table 2.

### Comparative Examples 1, 2

As shown in Table 2, except that the oil-resistant coating material was changed and that the bar number of the bar coater was changed from 14 to 18 at the time of coating, paper coated with the oil-resistant coating materials was obtained like Example 1. In addition, in the same way as in Example 1, the Kit value and the breathability were measured. The results were shown in Table 2.

### Comparative Example 5

Since a coating solution for the oil-resistant coating material could not be prepared, coating evaluation was not performed.

### Comparative Example 6

As shown in Table 2, except that the oil-resistant coating material was changed and that the bar number of the bar coater was changed from 14 to 32 at the time of coating, paper coated with the oil-resistant coating materials was obtained like Example 1. In addition, in the same way as in Example 1, the Kit value and the breathability were measured. The results were shown in Table 2.

TABLE 2

| | | | Air |
|---|---|---|---|
| | | Kit | permeability |
| | Oil-resistant coating material | value | (sec.) |
| Example 1 | Oil-resistant coating material 1 | 5 | 110 |
| Example 2 | Oil-resistant coating material 2 | 5 | 88 |
| Example 3 | Oil-resistant coating material 3 | 6 | 108 |
| Example 4 | Oil-resistant coating material 4 | 5 | 140 |
| Example 5 | Oil-resistant coating material 5 | 6 | 120 |
| Example 6 | Oil-resistant coating material 6 | 6 | 113 |
| Example 7 | Oil-resistant coating material 7 | 6 | 102 |
| Example 8 | Oil-resistant coating material 8 | 5 | 128 |
| Example 9 | Oil-resistant coating material 9 | 6 | 120 |
| Example 10 | Oil-resistant coating material 10 | 5 | 135 |
| Example 11 | Oil-resistant coating material 16 | 5 | 129 |
| Comparative | Oil-resistant coating material 11 | 3 | 56 |
| Example 1 | | | |
| Comparative | Oil-resistant coating material 12 | 3 | 68 |
| Example 2 | | | |
| Comparative | Oil-resistant coating material 13 | 3 | 125 |
| Example 3 | | | |
| Comparative | Oil-resistant coating material 14 | 4 | 120 |
| Example 4 | | | |
| Comparative | Oil-resistant coating material 15 | — | — |
| Example 5 | | | |
| Comparative | Oil-resistant coating material 17 | 5 | 2460 |
| Example 6 | | | |

When Examples 1 to 11 satisfying the conditions of the invention and Comparative Examples 1 to 5 not satisfying the conditions of the invention are compared, it is known that the oil resistance of the paper in the case of being coated with the aqueous-emulsion oil-resistant coating materials used in Examples 1 to 11 was excellent, and the breathability of the paper was high. By comparing Comparative Examples 3 and 4 using paraffin wax consisting of components derived from fossil fuels and Examples 1, 3, and 8 using a bio-derived component as Component (a), it is known that excellent oil resistance is exhibited even in a material having carbon neutrality.

It is known that Comparative Example 6 in which the mixture liquid of paraffin wax and starch prepared together based on Example 1 of Japanese Laid-open No. 2013-237941 was worse, in terms of breathability, than and thus inferior to Examples 1 to 10 of the invention.

1. An aqueous-emulsion oil-resistant coating material, comprising: Component (a), which is hardened castor oil and/or rice wax; Component (b), which is polyvinyl alcohol and/or casein; and water.

2. The aqueous-emulsion oil-resistant coating material as claimed in claim 1, wherein Component (a) and Component (b) are comprised in a ratio of Component (a)/Component (b)=100/1 to 20 as a mass ratio.

3. The aqueous-emulsion oil-resistant coating material as claimed in claim 1, wherein Component (a) is hardened castor oil.

4. The aqueous-emulsion oil-resistant coating material as claimed in claim 1, wherein Component (b) is casein.

5. A method for producing paper, comprising coating the aqueous-emulsion oil-resistant coating material as claimed in claim 1.

6. Paper, having a coating layer comprising the aqueous-emulsion oil-resistant coating material as claimed in claim 1.
